(19) United States
(12) Patent Application Publication
(10) Pub. No.: US 2020/0394563 A1
(43) Pub. Date: Dec. 17, 2020

(54) MACHINE LEARNING APPARATUS

(71) Applicant: AISIN SEIKI KABUSHIKI KAISHA, Kariya-shi (JP)

(72) Inventors: Yoshihito KOKUBO, Kariya-shi (JP); Yoshihisa SUETSUGU, Kariya-shi (JP); Jun ADACHI, Kariya-shi (JP); Koki UEDA, Kariya-shi (JP)

(73) Assignee: AISIN SEIKI KABUSHIKI KAISHA, Kariya-shi (JP)

(21) Appl. No.: 16/896,770

(22) Filed: Jun. 9, 2020

(30) Foreign Application Priority Data
Jun. 17, 2019 (JP) 2019-112260

(51) Int. Cl. G06N 20/00; G06K 9/62; G06F 17/18

(52) U.S. Cl. CPC G06N 20/00; G06F 17/18; G06K 9/628; G06K 9/6202

(57) ABSTRACT

A machine learning apparatus includes: an estimating unit estimating, for each of classes into which an element is classified, a likelihood indicating a probability of being classified into the class for an element contained in learning data based on a learning model; a loss value calculation unit calculating a loss value indicating a degree of error of the likelihood based on the likelihood for each class estimated by the estimating unit and a loss function; a weight calculation unit calculating a weight based on a comparison between a first likelihood for a first class to which the element is to be classified as true and a second likelihood for another class to which the element is not to be classified as true among the likelihoods calculated for the classes; and a machine learning unit causing the learning model to perform machine learning based on the loss value and the weight.

### CROSS REFERENCE TO RELATED APPLICATIONS

This application is based on and claims priority under 35 U.S.C. § 119 to Japanese Patent Application 2019-112260, filed on Jun. 17, 2019, the entire content of which is incorporated herein by reference.

### TECHNICAL FIELD

This disclosure relates to a machine learning apparatus.

### BACKGROUND DISCUSSION

In related art, a technique of classifying elements contained in data using a learning model generated by machine learning has been proposed.

Further, a technique has been proposed in which a loss value is calculated using a loss function for a classification result obtained by using a learning model, and learning of the learning model is performed using the loss value. In recent years, a method of calculating a loss value tends to become complicated with development of a technique. In a technique of related art described in JP 2015-1968A (Reference 1), a technique has been proposed in which a loss value is calculated by comparing a likelihood of a true value with a likelihood of an estimated value for each class to improve feedback efficiency.

However, in the technique of related art, a relationship between a class with the highest likelihood among the estimated values and other classes is not considered, and there is room for further improvement in improving the feedback efficiency by using the relationship.

### SUMMARY

A machine learning apparatus according to an aspect of this disclosure includes: an estimating unit configured to estimate, for each of a plurality of classes into which an element is classified, a likelihood indicating a probability of being classified into the class for an element contained in learning data based on a learning model; a loss value calculation unit configured to calculate a loss value indicating a degree of error of the likelihood based on the likelihood for each class estimated by the estimating unit and a predetermined loss function; a weight calculation unit configured to calculate a weight based on a comparison result between a first likelihood for a first class to which the element is to be classified as true and a second likelihood for another class to which the element is not to be classified as true among the likelihoods calculated for the respective classes; and a machine learning unit configured to cause the learning model to perform machine learning based on the loss value and the weight, for example.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a diagram showing an example of a hardware configuration of a machine learning apparatus according to an embodiment;

FIG. 2 is a block diagram showing a software configuration of the machine learning apparatus according to the embodiment;

FIG. 3 is a diagram showing an example of image data for learning according to the embodiment;

FIG. 4 is a diagram showing an estimating method when an estimating unit classifies elements using a learning model according to the embodiment;

FIG. 5 is a graph showing weights calculated based on difference values by a weight calculation unit according to the embodiment; and

FIG. 6 is a flowchart showing a processing procedure executed by the machine learning apparatus according to the embodiment.

### DETAILED DESCRIPTION

Hereinafter, an exemplary embodiment disclosed here will be disclosed. A configuration of the embodiment shown below and actions, results, and effects provided by the configuration are examples. This disclosure can be implemented by configurations other than those disclosed in the following embodiment, and can obtain at least one of various effects based on the basic configuration and derivative effects.

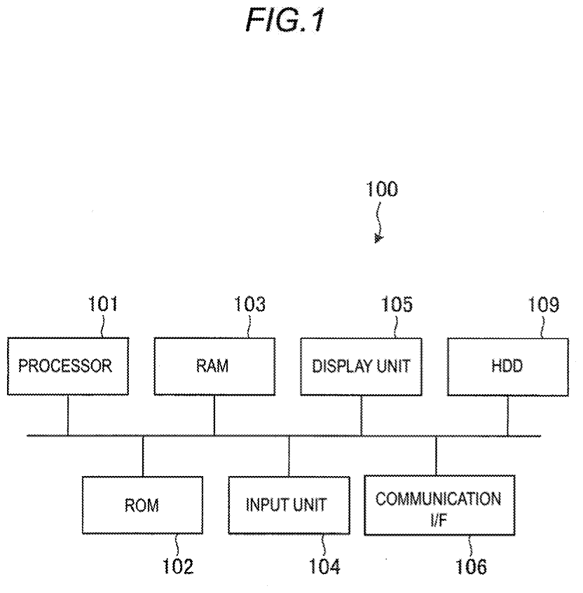

FIG. 1 is a diagram showing an example of a hardware configuration of a machine learning apparatus 100. As shown in FIG. 1, the machine learning apparatus 100 includes a processor 101, a ROM 102, a RAM 103, an input unit 104, a display unit 105, a communication I/F 106, and an HDD 109. In this example, the machine learning apparatus 100 includes a hardware configuration similar to that of a normal computer. Note that hardware elements included in the machine learning apparatus 100 are not limited to hardware elements shown in FIG. 1, and may further include, for example, a camera.

The processor 101 is a hardware circuit including, for example, a CPU, a GPU, an MPU, an ASIC or the like, and comprehensively controls an operation of the machine learning apparatus 100 by executing a program to implement various functions of the machine learning apparatus 100. The various functions of the machine learning apparatus 100 will be described later.

The ROM 102 is a nonvolatile memory, and stores various data including a program for activating the machine learning apparatus 100. The RAM 103 is a volatile memory having a work area of the processor 101.

The input unit 104 is a device for a user who uses the machine learning apparatus 100 to perform various operations. The input unit 104 includes, for example, a mouse, a keyboard, a touch panel, or a hardware key.

The display unit 105 displays various types of information. The display unit 105 includes, for example, a liquid crystal display, an organic electro luminescence (EL) display, or the like. Note that the input unit 104 and the display unit 105 may be integrally formed, for example, in a form of a touch panel. The communication I/F 106 is an interface for connecting to a network. The hard disk drive (HDD) 109 stores various data.

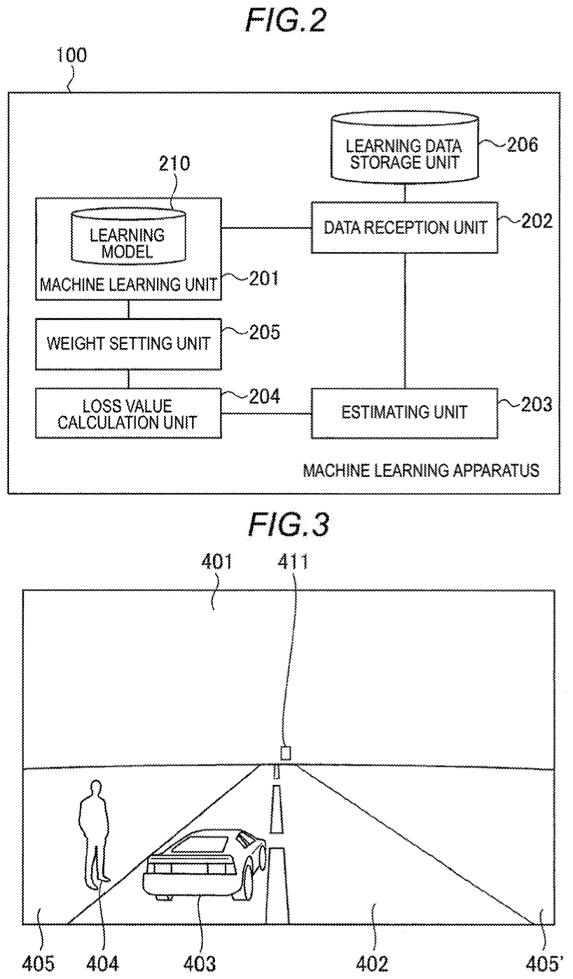

FIG. 2 is a block diagram showing a software configuration of the machine learning apparatus 100 according to the present embodiment. As shown in FIG. 2, in the machine learning apparatus 100, a machine learning unit 201, a data reception unit 202, an estimating unit 203, a loss value calculation unit 204, and a weight setting unit 205 are implemented by the processor 101 executing a program stored in the ROM 102 or the HDD 109. A learning data storage unit 206 is stored in the HDD 109.

The learning data storage unit 206 stores learning data. The learning data is used in learning for classifying elements (pixel according to the present embodiment) contained in the data for each class. The learning data includes, in addition to image data, information (shown below as a true value) indicating to which class each element (pixel according to the present embodiment) contained in the image data belongs.

Although the present embodiment describes a case where the learning data is image data, the learning data may also be other data such as a waveform. In addition, in the present embodiment, a case where the element to be classified is the pixel will be described, but the element may be other than the pixel.

The data reception unit 202 receives the learning data stored in the learning data storage unit 206, and receives a learning model 210 that has performed machine learning in the machine learning unit 201.

The learning model 210 may be any learning model. For example, a learned convolutional neural network (CNN) model may be used for image analysis.

FIG. 3 is a diagram showing an example of image data for learning according to the present embodiment. The image data shown in FIG. 3 includes five classes which are empty 401, a road surface 402, a vehicle 403, a person 404, and a ground 405. In the present embodiment, a case of classification into five classes will be described as an example. In the present embodiment, the number of classes is not limited, and may be four or less, or six or more.

Based on the learning model 210 that has performed machine learning in the machine learning unit 201, the estimating unit 203 calculates, for each of a plurality of classes into which the elements are classified, an estimated likelihood indicating a probability of being classified into the class of each element contained in the learning data.

Specifically, the estimating unit 203 according to the present embodiment calculates the estimated likelihood for each of five classes for each pixel of the image data for learning. In the present embodiment, a softmax function is used as an activation function for classification into a plurality of classes. Note that the present embodiment is not limited to a method using the softmax function, and another activation function may be used. The softmax function is a function that outputs a probability (estimated likelihood according to the present embodiment) that it is true for each class.

The estimated likelihood according to the present embodiment is a value that falls within a range of 0 to 1, and indicates that the closer to “1”, the higher the possibility of being in the class. Specifically, if the estimated likelihood is “0”, it indicates that the possibility of being in the class is 0 percent, and if the estimated likelihood is “1”, it indicates that the possibility of being in the class is estimated as 100 percent.

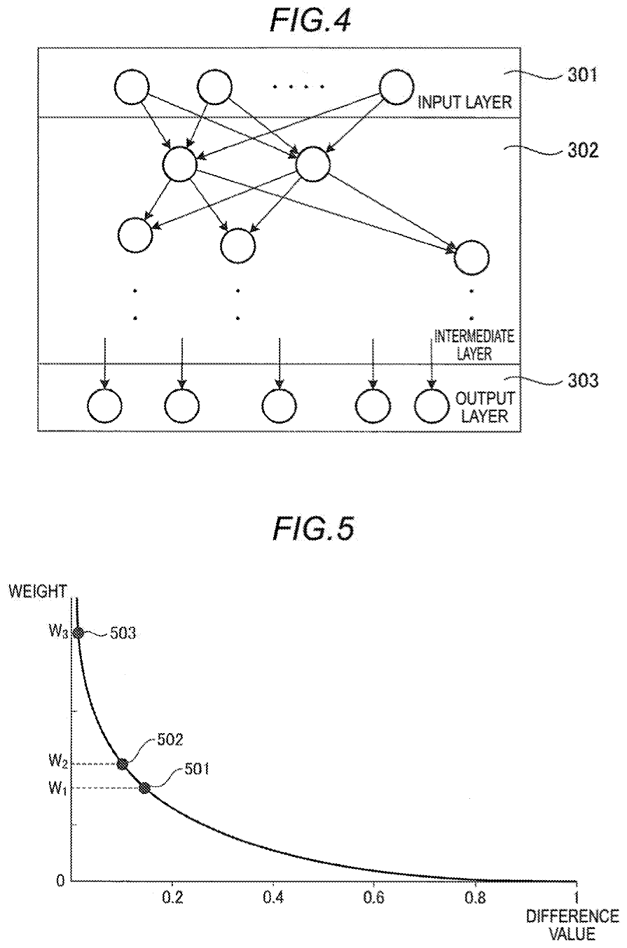

FIG. 4 is a diagram showing an estimating method when the estimating unit 203 classifies elements using the learning model 210 according to the present embodiment. As shown in FIG. 4, a plurality of input parameters is input in an input layer 301 so that the elements contained in the learning data are classified by the estimating unit 203. When the learning data is image data, in addition to a value of an element (pixel) to be classified, for example, a value of pixels around the element is also input as the input parameter.

As shown in FIG. 4, neurons are interconnected in a plurality of intermediate layers 302. In the present embodiment, parameters (for example, weight and bias) of each neuron are set according to the learning model 210. In an example shown in FIG. 4, the input parameters input to the input layer 301 are output as a plurality of output parameters present in an output layer 303 via the neurons interconnected in the plurality of intermediate layers 302. The number of output parameters according to the present embodiment coincides with the number of classes into which the elements are classified. In other words, the estimated likelihood for each class is calculated as the output parameter of the output layer 303.

Although the present embodiment describes an example in which a multi-class classification is performed, this disclosure is not limited to the multi-class classification, and may be applied to a case where a binary classification is performed.

A probability vector (an array of estimated likelihoods) output by the estimating unit 203 according to the present embodiment can be expressed as [class 1, class 2, class 3, class 4, class 5]. For example, when the class 1 is “empty”, the class 2 is “road surface”, the class 3 is “vehicle”, the class 4 is “person”, and the class 5 is “ground”, a pixel 411 in FIG. 3 stored in the learning data storage unit 206 indicates “empty”, so that a true value of the pixel 411 is [1, 0, 0, 0, 0].

Then, [0.40, 0.50, 0.05, 0.05, 0.00] is calculated as a first estimation example of the pixel 411.

In machine learning, relearning based on the first estimation example is performed. As a result, [0.40, 0.30, 0.10, 0.10, 0.10] is calculated as a second estimation example of the pixel 411. Further, relearning based on the second estimation example is performed. As a result, [0.40, 0.25, 0.20, 0.15, 0.00] is calculated as a third estimation example of the pixel 411. Note that the first estimation example to the third estimation example are examples for the following description, and are not limited whether the values are calculated by the machine learning of related art or according to the present embodiment.

In the first estimation example, the estimated likelihood for the class 2 that is false is larger than the estimated likelihood for the class 1 that is true. Therefore, the first estimation example does not coincide with the true value.

On the other hand, the second estimation example and the third estimation example coincide with the true value in that the estimated likelihood for the class 1 that is true is the largest. However, the estimated likelihood for the class 2 of the second estimation example is “0.30”, and the estimated likelihood for the class 2 of the third estimation example is “0.25”. Therefore, it is considered that a more appropriate classification is performed in the third estimation example than in the second estimation example.

Incidentally, for a calculation of the loss value due to the machine learning of related art, for example, a cross entropy function, only the estimated likelihood for the class that is true is used. In other words, in the first estimation example to the third estimation example described above, only “0.40” of the class 1 is used to calculate the loss value for machine learning. That is, since the machine learning is performed with the same value regardless of whether the value coincides with the true value or not, sufficient feedback cannot be performed. On the other hand, when the machine learning is performed using the estimated likelihoods for all classes, noise is large.

Therefore, in the present embodiment, weighting based on the estimated likelihood for the class to which the element should be classified as true and the highest estimated likelihood among the estimated likelihoods for another class to which the element should be classified as false is performed on the loss value.

The loss value calculation unit 204 calculates the loss value indicating a degree of error of the estimated likelihood based on the estimated likelihood for each class estimated by the estimating unit 203 and a predetermined loss function. In the present embodiment, a loss value L is calculated using the cross entropy function shown in the following equation (1) as the predetermined loss function. A variable i is a numerical value indicating a class. Therefore, in the present embodiment, since there are five classes, the variables i=0 to 4. tᵢ is “1” when the class is true, and is “0” when the class is false. yᵢ is the estimated likelihood for each class (i).

$$L = - {\sum }_{i = 0}^{4} \{ {t}_{i} \times log ( {y}_{i} ) \} \qquad ( 1 )$$

The weight setting unit 205 calculates the weight of the loss value. Specifically, the weight setting unit 205 calculates a weight W based on a comparison result between the estimated likelihood for the class (true class) to which a pixel (element) should be classified as true and the highest estimated likelihood among the estimated likelihoods for another class (false class) to which a pixel (element) should be classified as false (should not be classified as true) among the estimated likelihoods of each pixel (element) calculated for each class. In the present embodiment, as the comparison result, the weight W is calculated based on a difference between the estimated likelihood for the true class and the highest estimated likelihood for the false class.

However, when the estimated likelihood for the false class is larger than the estimated likelihood for the true class, the weight setting unit 205 sets a predetermined value as the weight. The predetermined value may be set to an appropriate value according to the embodiment. For example, the predetermined value is set to a value larger than that of the weight calculated when the estimated likelihood for the true class is larger than the highest estimated likelihood for the false class.

Specifically, the difference value p is calculated using the following equation (2). The estimated likelihood for the true class is set as V_{target}, and the highest estimated likelihood for the false class is set as V_{rem_max}.

p=max(0.01,V_{target}−V_{rem_max}) (2)

According to equation (2), when the highest estimated likelihood for the false class is larger than the estimated likelihood for the true class, the difference value p=0.01, and when the estimated likelihood for the true class is larger than the highest estimated likelihood for the false class, the difference value p=V_{target}−V_{rem_max}.

Further, the weight setting unit 205 substitutes the calculated difference value p into the following equation (3) to calculate the weight W. Note that a predetermined value y is set to an appropriate value according to the embodiment. For example, it is conceivable that a numerical value between 0 and 5.0 is assigned.

W=−(1−p)^{y} log(p) (3)

FIG. 5 is a graph showing the weight W calculated by equation (3) based on the difference value p by the weight setting unit 205. As shown in FIG. 5, the difference value p takes a value between 0 and 1. As the value approaches 0, the weight W increases.

For example, in a case of the first estimation example [0.40, 0.50, 0.05, 0.05, 0.00], since the highest estimated likelihood for the false class is larger than the estimated likelihood for the true class, a difference value p1=0.01. In this case, the weight setting unit 205 calculates a weight W₃ corresponding to a coordinate 503.

On the other hand, in a case of the second estimation example [0.40, 0.30, 0.10, 0.10, 0.10], a difference value p2=0.1. In this case, the weight setting unit 205 calculates a weight W₂ corresponding to a coordinate 502. In a case of the third estimation example [0.40, 0.25, 0.20, 0.15, 0.00], a difference value p3=0.15. In this case, the weight setting unit 205 calculates a weight W₁ corresponding to a coordinate 501.

As shown in FIG. 5, W₃>W₂>W₁. That is, in the present embodiment, the large weight W₃ is set when the estimated likelihood for the false class is larger than the estimated likelihood for the true class. Further, when the estimated likelihood for the true class is larger than the highest estimated likelihood for the false class, the weight W is set to decrease as the difference value between the estimated likelihoods increases as shown in FIG. 5. In other words, when the difference value between the estimated likelihoods is small, a large weight W is set. As a result, the efficiency of machine learning can be improved.

As described above, in the present embodiment, even when the estimated likelihood for the true class is the same, a weight W is calculated differently according to the difference value p.

The machine learning unit 201 performs the machine learning based on the loss value L and the weight W to perform feedback to the learning model 210. Specifically, in the present embodiment, as the machine learning based on the loss value L and the weight W, instead of using the loss value L as in related art, a total loss value L_{L} calculated based on the following equation (4) is used. A method for causing the learning model 210 to perform machine learning using the total loss value L_{L} may be the same as a method of related art, and a description thereof will be omitted.

L_{L}=L×W (4)

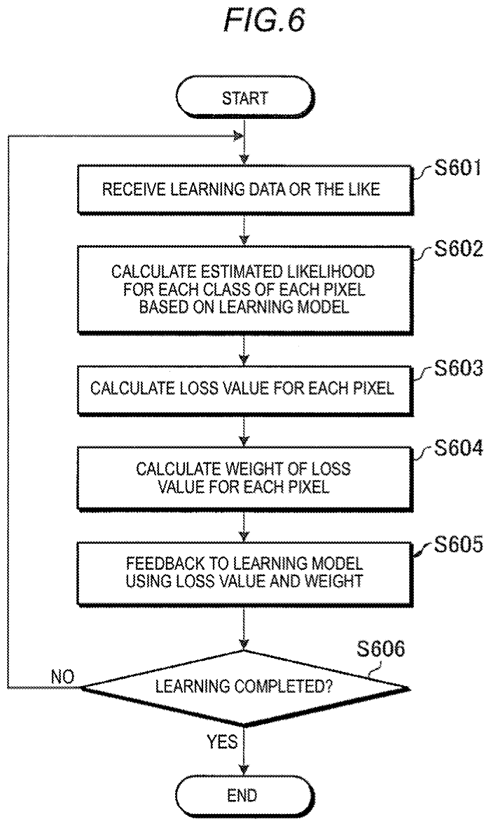

Next, a processing procedure executed by the machine learning apparatus 100 according to the present embodiment will be described. FIG. 6 is a flowchart showing the processing procedure executed by the machine learning apparatus 100 according to the present embodiment.

The data reception unit 202 of the machine learning apparatus 100 according to the present embodiment receives the learning model 210 that has performed machine learning in the machine learning unit 201 together with the learning data (image data) from the learning data storage unit 206 (S601).

Next, the estimating unit 203 calculates the estimated likelihood of each pixel (element) in the learning data for each class based on the learning model 210 (S602).

Then, the loss value calculation unit 204 calculates the loss value for each pixel (element) based on the estimated likelihood estimated by the estimating unit 203 and the predetermined loss function (for example, a cross entropy function) (S603).

Further, the weight setting unit 205 calculates the weight of the loss value for each pixel (element) based on the estimated likelihood for the true class and the highest estimated likelihood for the false class (S604).

Then, the machine learning unit 201 performs machine learning using the loss value and the weight to perform feedback to the learning model 210 (S605).

Thereafter, the machine learning unit 201 determines whether the machine learning is completed (S606). A criterion for determining whether the machine learning is completed may be any criterion. For example, the criterion may be a case where a specified number of learning times is reached, a case where the learning model 210 exceeds target accuracy, or a case where the machine learning based on all learning data is completed.

When the machine learning unit 201 determines that the machine learning is not completed (S606: No), the processing is performed again from S601. On the other hand, when it is determined that the machine learning is completed (S606: Yes), the processing is completed.

In the present embodiment, the flowchart shown in FIG. 6 is described, but parallel processing may be performed for machine learning using the learning model 210.

In the present embodiment, the cross entropy function is used as a method of calculating the loss value as an example, but a loss function other than the cross entropy function may also be used. For example, a method such as a least square error may be used. Further, a calculation method of calculating the loss value is not limited to a method using only one calculation method, and a plurality of calculation methods for the loss value may be combined.

When a plurality of loss values are calculated for each pixel (element) by using a plurality of calculation methods, the machine learning may be performed after integrating the loss values of all elements into one. In such a case, it is conceivable to use an average or a sum to integrate the loss values.

In the embodiment described above, an example is described in which the highest estimated likelihood among the estimated likelihoods for the false classes is compared with the estimated likelihood for the true class. However, in the present embodiment, a comparison target with the estimated likelihood for the true class is not limited to the highest estimated likelihood among the estimated likelihoods for the false classes, and the estimated likelihood for the true class may be compared with an average of the estimated likelihoods for the false classes, a second highest estimated likelihood, or the like.

In the present embodiment, the weight based on the estimated likelihood for the true class and the highest estimated likelihood for the false class is set, so that the feedback efficiency to the learning model 210 can be improved as compared with a case where the machine learning using the loss value L of the related art is performed.

While certain embodiments have been described, these embodiments have been presented by way of example only, and are not intended to limit the scope of the disclosures. These novel embodiments can be implemented in various other forms, and various omissions, substitutions and changes can be made without departing from the spirit of the disclosure. These embodiments and modifications thereof are included in the scope and gist of the embodiments, and are included in the embodiments described in the claims and the equivalent scope thereof.

A machine learning apparatus according to an aspect of this disclosure includes: an estimating unit configured to estimate, for each of a plurality of classes into which an element is classified, a likelihood indicating a probability of being classified into the class for an element contained in learning data based on a learning model; a loss value calculation unit configured to calculate a loss value indicating a degree of error of the likelihood based on the likelihood for each class estimated by the estimating unit and a predetermined loss function; a weight calculation unit configured to calculate a weight based on a comparison result between a first likelihood for a first class to which the element is to be classified as true and a second likelihood for another class to which the element is not to be classified as true among the likelihoods calculated for the respective classes; and a machine learning unit configured to cause the learning model to perform machine learning based on the loss value and the weight, for example. According to the configuration, for example, when the learning model is caused to perform machine learning, not only the loss value but also the weight based on the comparison result between the first likelihood and the second likelihood is used for machine learning, so that the likelihood for another class to which the element should not be classified as true is also considered. Accordingly, feedback efficiency can be improved.

In the machine learning apparatus according to the aspect of this disclosure, for example, the weight calculation unit may calculate the weight based on the comparison result between the first likelihood and the second likelihood which is the highest among the likelihoods for the other classes. According to the configuration, for example, by using the second likelihood which is the highest among the likelihoods for the other classes, the feedback efficiency can be improved.

In the machine learning apparatus according to the aspect of this disclosure, for example, the weight calculation unit may calculate the weight further based on a difference between the first likelihood and the second likelihood. According to the configuration, for example, by using the weight based on the difference between the first likelihood and the second likelihood for machine learning, a relationship between the class with the highest likelihood of the estimated values and the other classes is also considered, so that the feedback efficiency can be improved.

In the machine learning apparatus according to the aspect of this disclosure, for example, the weight calculation unit may calculate the weight W by substituting a difference value p between the first likelihood and the second likelihood, and a predetermined value y into “W=−(1−p)^{y} log(p)”. According to the configuration, for example, by calculating the weight based on the equation, the weight increases as the difference between the first likelihood and the second likelihood decreases, so that the feedback efficiency can be improved.

In the machine learning apparatus according to the aspect of this disclosure, for example, when the second likelihood is larger than the first likelihood, the weight calculation unit may further set, as the weight, a value larger than that of a weight calculated when the first likelihood is larger than the second likelihood. According to the configuration, for example, when the second likelihood is larger than the first likelihood, the weight is set to be large, so that the feedback efficiency can be improved.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A machine learning apparatus, comprising:
an estimating unit configured to estimate, for each of a plurality of classes into which an element is classified, a likelihood indicating a probability of being classified into the class for an element contained in learning data based on a learning model;
a loss value calculation unit configured to calculate a loss value indicating a degree of error of the likelihood based on the likelihood for each class estimated by the estimating unit and a predetermined loss function;
a weight calculation unit configured to calculate a weight based on a comparison result between a first likelihood for a first class to which the element is to be classified as true and a second likelihood for another class to which the element is not to be classified as true among the likelihoods calculated for the respective classes; and
a machine learning unit configured to cause the learning model to perform machine learning based on the loss value and the weight.

2. The machine learning apparatus according to claim 1, wherein
the weight calculation unit calculates the weight based on the comparison result between the first likelihood and the second likelihood which is the highest among the likelihoods for the other classes.

3. The machine learning apparatus according to claim 1, wherein
the weight calculation unit calculates the weight further based on a difference between the first likelihood and the second likelihood.

4. The machine learning apparatus according to claim 3, wherein
the weight calculation unit calculates the weight W by substituting a difference value p between the first likelihood and the second likelihood, and a predetermined value y into the following equation (1)
W=−(1−p)^{y} log(p) (1).

5. The machine learning apparatus according to claim 1, wherein
when the second likelihood is larger than the first likelihood, the weight calculation unit sets, as the weight, a value larger than that of a weight calculated when the first likelihood is larger than the second likelihood.
